(19) United States
(12) Patent Application Publication
(10) Pub. No.: US 2018/0039705 A1
(43) Pub. Date: Feb. 8, 2018

(54) METHOD AND SYSTEM FOR ANALYSIS OF USER DATA BASED ON SOCIAL NETWORK CONNECTIONS

(71) Applicant: MOGIMO, INC., New York, NY (US)

(72) Inventors: Gil EYAL, Hoboken, NJ (US); Guy TAMIR, Kfar Saba (IL)

(73) Assignee: MOGIMO, INC., New York, NY (US)

(21) Appl. No.: 15/550,627

(22) PCT Filed: Feb. 10, 2016
(86) PCT No.: PCT/US16/17245

§ 371 Date: Aug. 11, 2017

Related U.S. Application Data
(60) Provisional application No. 62/115,227, filed on Feb. 12, 2015.

(51) Int. Cl. G06F 17/30; G06Q 50/00; H04L 29/08

(52) U.S. Cl. CPC G06F 17/30867; G06F 17/3087; G06F 17/30241; H04L 67/306; G06Q 50/01

(57) ABSTRACT

A method for analyzing user data based on social network connections includes: storing a plurality of association profiles, each profile including a name, demographic labels, and, for each demographic label, an associated demographic value; receiving user data related to a user of a social network including a provided name for a plurality of connected users; identifying, for each provided name, a related association profile where the included name corresponds to the respective provided name; aggregating, for each demographic label, the associated demographic value included in each of the identified related association profiles to obtain, for each demographic label, demographic metrics; and storing, in the user database, a user profile, that includes each demographic label and associated one or more demographic metrics.

### FIELD

The present disclosure relates to analyzing user data based on social network data and connections to the user, specifically the analysis of names associated with connections to a social network user and the attribution of demographic data to names to determine demographics of the user's connections on the social network.

### BACKGROUND

Social networks have become extremely prevalent in the lives of many people. Social networks enable people to connect to others, share ideas, experiences, thoughts, etc., and to stay in touch with others and communicate with others on a large scale through the use of available technologies. While social networks often retain data regarding their users, this data may often be of little value to third parties. However, what data social networks do have available on users, such as their name and geographic location, may be useful when combined with other available data sources. Unfortunately, there is a lack of computing systems capable of combining social network data with other available data sources to make use of such information.

Thus, there is a need for a technical solution for the development of a computing system specifically programmed to be able to combined social network data with other available data sources to greatly increase the utility of such data. More specifically, the analysis of the names of users connected to a social network user as the names relate to demographics and other information may provide for a detailed look at the demographics over which the social network user has influence, which may be unavailable via any other method. As such, the analysis of names presents an opportunity that is currently unavailable using existing technological systems.

### SUMMARY

The present disclosure provides a description of systems and methods for analyzing user data based on social network connections.

A method for analyzing user data based on social network connections includes: storing, in an association database of the processing server, a plurality of association profiles, wherein each association profile includes a structured data set related to a data association including at least a name, one or more demographic labels, and, for each demographic label, an associated demographic value; receiving, by a receiving device of the processing server, a data signal encoded with user data, wherein the user data is related to a user of a social network and includes at least a provided name for a plurality of connected users associated with the related user on the social network; executing, by a querying module of the processing server, a query on the associated database to identify, for each provided name included in the user data, a related association profile where the included name corresponds to the respective provided name; aggregating, by a data aggregation module of the processing server, for each demographic label, the associated demographic value included in each of the identified related association profiles to obtain, for each demographic label, one or more demographic metrics; and executing, by the querying module of the processing server, a query on a user database of the processing server to store, in the user database, a user profile, wherein the user profile includes a structured data set related to the user of the social network including at least each demographic label and associated one or more demographic metrics.

A system for analyzing user data based on social network connections includes: an association database of the processing server configured to store a plurality of association profiles, wherein each association profile includes a structured data set related to a data association including at least a name, one or more demographic labels, and, for each demographic label, an associated demographic value; a receiving device of the processing server configured to receive a data signal encoded with user data, wherein the user data is related to a user of a social network and includes at least a provided name for a plurality of connected users associated with the related user on the social network; a querying module of the processing server configured to execute a query on the associated database to identify, for each provided name included in the user data, a related association profile where the included name corresponds to the respective provided name; and a data aggregation module of the processing server configured to aggregate for each demographic label, the associated demographic value included in each of the identified related association profiles to obtain, for each demographic label, one or more demographic metrics. The querying module of the processing server is further configured to execute a query on a user database of the processing server to store, in the user database, a user profile, wherein the user profile includes a structured data set related to the user of the social network including at least each demographic label and associated one or more demographic metrics.

A non-transitory computer readable recording medium configured to store program code executable by a processing device of a computing system for analyzing user data based on social network connections, wherein the program code is configured to cause the computing system to: store, in an association database of the processing server, a plurality of association profiles, wherein each association profile includes a structured data set related to a data association including at least a name, one or more demographic labels, and, for each demographic label, an associated demographic value; receive, by a receiving device of the processing server, a data signal encoded with user data, wherein the user data is related to a user of a social network and includes at least a provided name for a plurality of connected users associated with the related user on the social network; execute, by a querying module of the processing server, a query on the associated database to identify, for each provided name included in the user data, a related association profile where the included name corresponds to the respective provided name; aggregate, by a data aggregation module of the processing server, for each demographic label, the associated demographic value included in each of the identified related association profiles to obtain, for each demographic label, one or more demographic metrics; and execute, by the querying module of the processing server, a query on a user database of the processing server to store, in the user database, a user profile, wherein the user profile includes a structured data set related to the user of the social network including at least each demographic label and associated one or more demographic metrics.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for analyzing user data based on social network connections and name and demographic associations in accordance with exemplary embodiments.

FIG. 2 is a block diagram illustrating the processing server of FIG. 1 for the analysis of name and demographic associations for connections to a social network user in accordance with exemplary embodiments.

FIG. 3 is a flow diagram illustrating a process for analyzing demographics of connections to a social network user based on name and demographic associations using the system of FIG. 1 in accordance with exemplary embodiments.

FIG. 4 is a flow diagram illustrating a process for identifying social network users with target demographic influences based on connection names using the system of FIG. 1 in accordance with exemplary embodiments.

FIG. 5 is a diagram illustrating a report of demographics of connections to a social network user based on name and demographic associations in accordance with exemplary embodiments.

FIG. 6 is a flow chart illustrating an exemplary method for analyzing user data based on social network connections in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Analysis of Social Network User Data Based on Connection Names

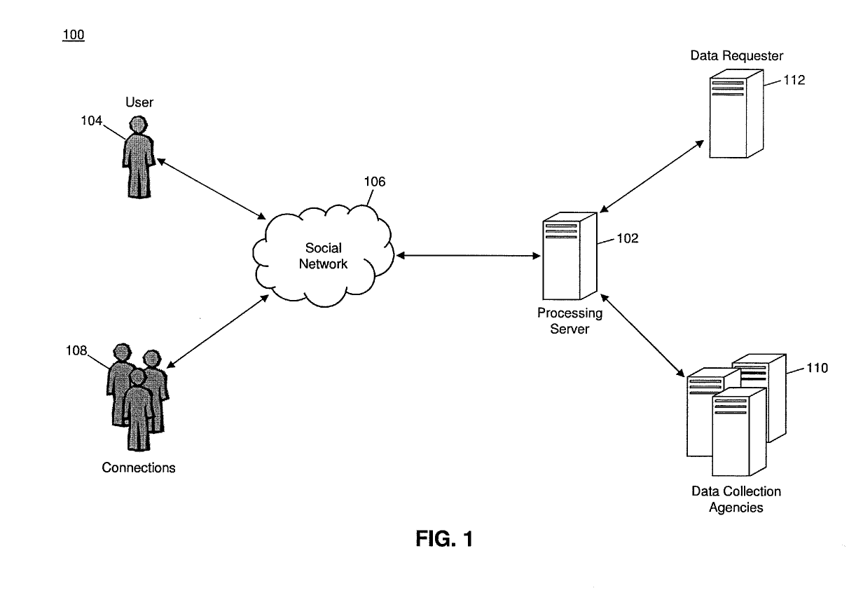

FIG. 1 illustrates a system 100 for the analysis of user data for a social network user to determine the demographics of connected users based on associations between names and demographics for connections to the social network user.

The system 100 may include a processing server 102. The processing server 102, discussed in more detail below, may be configured to analyze user data associated with a user 104 of a social network 106 to determine the demographics of a plurality of connections 108 to the user 104 on the social network 106. The social network 106 may be any suitable type of social network that registers users and that collects at least a name for their registered users, such as Facebook®, Twitter®, Instagram®, LinkedIn®, etc. The name associated with each user 104 and connection 108 of the social network 106 may be a family name, last name, or surname, first name or given name, middle name, a combination thereof, or any other type of name that may be suitable for performing the functions discussed herein.

As part of the registration process for the social network 106, the social network 106 may collect user data associated with each registrant. The user data may include at least the user's name and communication data suitable for use in communicating with the respective user. The communication data may include, for instance, an e-mail address, telephone number, device identifier, etc. The user 104 may register with the social network 106, providing their registration information. The user 104 may then connect with a plurality of connections 108 using the social network 106. Each connection 108 may be another user of the social network 106 with whom the user 104 wishes to connect, or vice versa. For instance, the user 104 may select one or more connections 108 for which the user 104 desires to see content from or share content with using the social network 106. In another instance, connections 108 may select the user 104 to view content shared by the user 104 using the social network 106. In some cases, a social network 106 may or may not require mutual acceptance to establish a connection between the user 104 and a connection 108. For example, a connection 108 may “follow” (e.g., subscribe to content shared by the user 104) the user 104 without requiring the user 104 to consent to the action.

The processing server 102 may be configured to analyze the connections 108 for the user 104 to determine the demographics of the group of connections 108. The processing server 102 may receive connection information for the user 104 from the social network 106. In some embodiments, the processing server 102 may electronically transmit a data signal encoded with a request to the social network 106, where the request may indicate the user 104 for which data is requested. In other embodiments, the social network 106 may electronically transmit data signals to the processing server 102 encoded with user data for one or more users 104 for use in performing the functions discussed herein. In some cases, the processing server 102 may be a part of the social network 106 and may perform the actions discussed herein using user data stored internally or otherwise accessible to the social network 106. The user data may include at least a name for a plurality of connections 108 associated with the user 104.

The processing server 102 may receive name and demographic associations from one or more data collection agencies 110 included in the system 100. The data collection agencies 110 may be entities configured to collect data regarding associations between names and demographics. Demographics may include age, age range, birth year, birth year range, gender, ethnicity, nationality, geographic location, and any other type of characteristic associated with demographics. In some instances, these characteristics may include education, residential status, marital status, familial status, occupation, income, etc. In some cases, some demographic characteristics may not be directly associated with a name. Data collection agencies 110 may directly associate a name to one or more demographic characteristics, based on a prevalence of a connection between the name and respective characteristic. For example, the name “Liam” may be associated with males born between the years 2011-2014, due to its popularity as a name for males during that time period, and lack of popularity in other time periods. In a further example, the name “Liam” may be associated with the United States, Canada, and Great Britain due to its popularity in those countries and a lack of popularity in other countries. The data collection agencies 110 may collect data regarding such associations between names and demographics, and may collect the data using suitable collection methods, which may include the consulting of one or more additional sources. For example, the Social Security Administration may be a data collection agency 110 or may provide data to one or more data collection agencies 110 for generation of the associations used herein.

Each data collection agency 110 may electronically transmit data signals encoded with name and demographic association data to the processing server 102 using a suitable communication network and method. Suitable communication networks may include, for example, the Internet, local area networks, wireless area networks, radio frequency networks, cellular communication networks, etc. The processing server 102 may receive the name and demographic associations and may store them in a locally stored or otherwise accessible database, such as an association database, discussed in more detail below. The processing server 102 may then identify the demographics associated with each name for the connections 108 associated with a user 104 for which user data is received from the social network 106.

Such analysis may include identifying the demographics associated with each individual name of the connections 108 for the user 104, and then the aggregation of the demographics. For example, the processing server 102 may identify a gender associated with each name for the connections 108 and then may aggregate the genders to determine a percentage of connections 108 for the user 104 associated with each gender. The processing server 102 may repeat the process for each demographic characteristic, such as determining percentages for age and/or birth year, ethnicity, nationality, etc. In some instances, the processing server 102 may only aggregate the connections 108 for which such demographics are available. In some cases, the number of connections 108 aggregated for each characteristic may be different. For example, the user 104 may have 100 connections. Gender information may be available for each name for the 100 connections, but ethnicity information may only be available for 70 of the connections (e.g., due to a lack of available data for the name, no specific association for the name, etc.). In such an instance, the gender percentages may be based on all 100 connections, while ethnicity information may be based on the 70 connections for which data is available.

The processing server 102 may perform the aggregation and may represent the demographics for the connections 108 for the user 104 as percentages, ratios, or other suitable type of representation. In some instances, the processing server 102 may identify the most common value for each demographic characteristic. For example, the processing server 102 may analyze a user 104 to determine the most common gender, ethnicity, and nationality of their connections 108. In some cases, the processing server 102 may identify the percentages or rates of specifically requested demographics, such as identifying what portion of connections 108 for a user 104 are located in a specified country.

Once the demographics for the connections 108 of a user 104 have been identified, the processing server 102 may store the data in a locally stored or otherwise accessible database, such as a user database, discussed in more detail below. In some embodiments, the system 100 may include a data requester 112. The data requester 112 may electronically transmit a data signal to the processing server 102 via a suitable communication network that is encoded with a demographic request. The demographic request may indicate a user 104 for which the demographics of that user's connections 108 is requested. The processing server 102 may identify the demographics, such as discussed above, and may electronically transmit a return data signal to the data requester 112 that is encoded with the identified demographic data.

In some embodiments, a data requester 112 may request users that have connections 108 matching one or more specified criteria. For example, the data requester 112 may request users 104 whose connections 108 are at least 70% female, have at least 50% between the ages of 16 and 35, and that are primarily located in North America. The processing server 102 may identify the demographics identified for a plurality of different users 104, such as stored in the user database, and may identify users 104 whose connection demographics match the specified criteria. The processing server 102 may then provide the users to the data requester 112. The data requester 112 may then reach out to the users 104 (e.g., as may be subject to terms and conditions set forth by the social network 106, users 104, connections 108, etc.) accordingly. For example, an advertising agency may contact a user 104 due to their connections 108 matching the target market for an advertisement, to broker a deal to have the user 104 share an advertisement or other suitable content to their connections 108.

In some embodiments, user data provided by the social network 106 may include data for each connection 108 in addition to their provided name. For example, connections 108 may also provide a geographic location, age, gender, ethnicity, nationality, or other demographic value to the social network 106 as part of the registration process. The social network 106 may provide this data to the processing server 102 in addition to the name. Such data may be used in the identification of demographic characteristics for each connection 108. For example, the social network 106 may provide a name and geographic location for each connection 108. The processing server 102 may then identify demographic characteristics based on associations between demographics and a combination of name and geographic location, as provided by the data collection agencies 110. For instance, the name “Ashley” may be primarily associated with the female gender in the United States, but may be primarily associated with the male gender in England. In such an instance, the demographics associated with the name “Ashley” may differ based on the geographic location.

In such embodiments, the processing server 102 may use a similar process as discussed above to identify demographics associated with connections 108 for a user 104, but may use different name and demographic associations, which may rely on a combination of name and other data provided by the social network 106 for each of the connections 108. In some embodiments, the processing server 102 may specifically request demographic associations from the data collection agencies 110 based on data provided by the social network 106. For example, if the social network 106 provides user data to the processing server 102 that includes a name and age range for each connection 108, the processing server 102 may request demographics associated with a combination of name and age range from the data collection agencies 110, and may then match those demographics to the connections 108 based on their names and age ranges accordingly.

Methods and systems discussed herein may enable the processing server 102 to identify the demographics for connections 108 associated with a user 104 of a social network 106 based on associations between demographics and names. By way of the specialized programming and configurations of the technical systems of the processing server 102 discussed herein, the processing server 102 may be configured to associate demographics to each of the connections 108, to aggregate the demographics to identify an approximate demographic analysis of the users associated with a specific user 104 of a social network 106. Such information may be beneficial for use in a variety of technologies and industries.

For example, an advertiser desiring to reach a specific demographic market may be able to identify ideal users 104 to serve as sponsors or spokespersons for advertised content. In another example, a user 104 may share negative content associated with a restaurant, such as a bad review of a dining experience, and the restaurant may be able to identify the demographics of the connections 108 to that user 104 via the processing server 102 to identify a suitable reaction to the user's bad experience. In yet another example, a politician running for an elected office may identify target users 104 for an endorsement based on the demographics of their connection, or may identify the demographics of connections 108 for users 104 that support their race for office as part of their campaign strategy.

### Processing Server

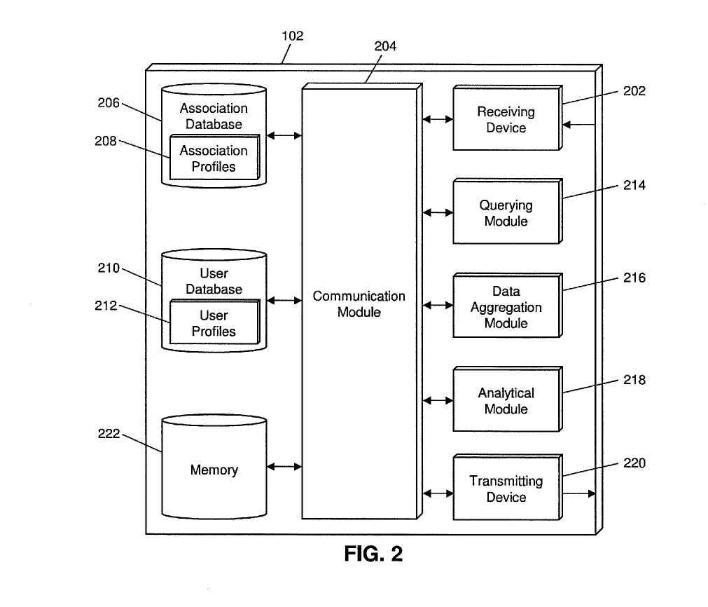

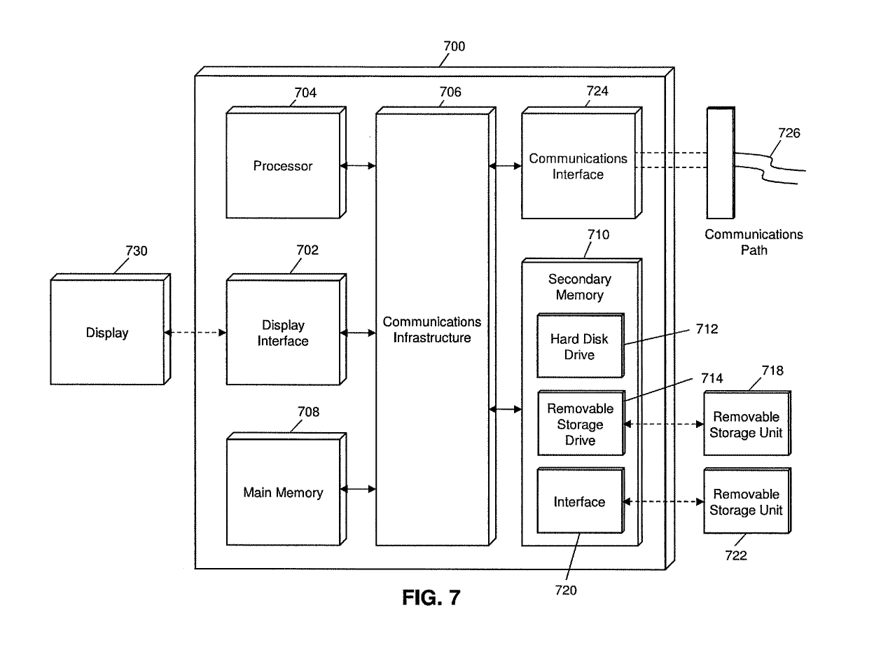

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from social networks 106, data collection agencies 110, data requesters 112, and other entities via alternative networks, such as the Internet. In some embodiments, the receiving device 202 may be comprised of multiple devices, such as different receiving devices for receiving data over different networks, such as a first receiving device for receiving data over a cellular communication network and a second receiving device for receiving data over the Internet. The receiving device 202 may receive electronically data signals that are transmitted, where data may be encoded in the data signal and decoded, parsed, read, or otherwise obtained via receipt of the data signal by the receiving device 202. In some instances, the receiving device 202 may include a parsing module for parsing the received data signal to obtain the data encoded therein. For example, the receiving device 202 may include a parser program configured to receive and transform the received data signal into usable input for the functions performed by the processing device to carry out the methods and systems described herein.

The receiving device 202 may be configured to receive data signals electronically transmitted by data collection agencies 110 encoded with name and demographic associations. In some instances, the demographic characteristics may be associated with names and additional values, such as a combination of name and geographic location. The receiving device 202 may also be configured to receive data signals electronically transmitted by social networks 106 that are encoded with user data. The user data may include names and any additional data associated with connections 108 connected to a user 104 of the social network 106. The receiving device 202 may also be configured to receive data signals electronically transmitted by data requesters 112, which may be encoded with data requests. The data requests may request demographic information for a specific user 104 or users of a social network 106, or may be request users 104 of social networks 106 whose connections 108 match specified demographic criteria.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, data aggregation module 216, analytical module 218, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include an association database 206. The association database 206 may be configured to store a plurality of association profiles 208 using a suitable data storage format and schema. The association database 206 may be a relational database that utilizes structured query language for the storage, identification, modifying, updating, accessing, etc. of structured data sets stored therein. Each association profile 208 may be a structured data set configured to store data related to a data association between names and one or more demographic characteristics. Each association profile 208 may include at least a name and one or more demographic labels and, for each demographic label, one or more associated demographic values. Demographic labels may include, for example, gender, age, age range, birth year, birth year range, ethnicity, nationality, geographic location, etc. Demographic values may include suitable values for the corresponding demographic label such as, for the label of gender, male or female.

The processing server 102 may also include a user database 210. The user database 210 may be configured to store a plurality of user profiles 212 using a suitable data storage format and schema. The user database 210 may be a relational database that utilizes structured query language for the storage, identification, modifying, updating, accessing, etc. of structured data sets stored therein. Each user profile 212 may be a structured data set configured to store data related to a user 104 of a social network 106. The user profile 212 may include user data associated with that user 104 provided by the social network 106, such as communication data, a user identification value, provided name, geographic location, etc., as well as data associated with connections 108 of the user 104, such as connection names. The user profile 212 may also include demographic data identified by the processing server 102 using the methods discussed herein for demographics associated with connections 108 of the user 104.

The processing server 102 may include a querying module 214. The querying module 214 may be configured to execute queries on databases to identify information. The querying module 214 may receive one or more data values or query strings, and may execute a query string based thereon on an indicated database, such as the association database 206 and user database 210, to identify information stored therein. The querying module 214 may then output the identified information to an appropriate engine or module of the processing server 102 as necessary. The querying module 214 may, for example, execute a query on the association database 206 to identify an association profile 208 for a name associated with a connection 108, for identification of the demographic values associated therewith. The querying module 214 may also be configured to execute a query on the user database 210 to identify a user profile 212 that matches a specified user or specified connection demographic criteria as requested by a data requester 112 (e.g., and received via the receiving device 202).

The processing server 102 may also include a data aggregation module 216. The data aggregation module 216 may be configured to aggregate data identified via the querying module 214. The data aggregation module 216 may receive a plurality of association profiles 208 and/or user profiles 212 or data included therein, may aggregate the data as per a received request, and may output the aggregated data. For example, the data aggregation module 216 may aggregate demographic values for one or more demographic labels for a plurality of association profiles 208 and/or the demographic values included therein for connections 108 for a user 104. The data aggregation module 216 may output the aggregated data to the querying module 214 for use in inserting into a related user profile 212 via a query on the user database 210, and/or may output the data to another module or engine of the processing server 102, such as for providing to a data requester 112 in response to a received request.

In some embodiments, the processing server 102 may also include an analytical module 218. The analytical module 218 may be configured to perform any additional analysis regarding connections 108 for a user 104 and data associated therewith. For instance, the analytical module 218 may be programmed to identify an ideal user 104 for specified demographic criteria provided by a data requester 112. For example, the data requester 112 may submit (e.g., as received by the receiving device 202) a request for a user 104 that has connections 108 with a high percentage of women between the ages of 25 and 39 located in North America. The querying module 214 may identify a plurality of user profiles 212 related to users that meet the criteria, and may pass them to the analytical module 218 for analysis and selection. The analytical module 218 may be configured to select a single user profile 212, such as based on weighted considerations of the criteria, number of connections 108, percentages of each criteria, etc., as may be set by the data requester 112 or one or more algorithms stored in the processing server 102. For instance, in the above example, the analytical module 218 may select a user 104 with a smaller percentage of women in the specified age range and location, but with such a large number of connections 108 that yields a greater target audience.

In some embodiments, the analytical module 218 may be configured to analyze association profiles 208 and name-year associations to estimate an age for the name of a connection 108. In one embodiment, the analytical module 218 may analyze the number of times a name was listed as a birth name in any given year (e.g., as received from data collection agencies 110). The analytical module 218 may calculate a percentage of total occurrences of that name for each year based on the total number of times the name was listed for all of the years as a total. The analytical module 218 may then multiply that percentage by the age of individuals born in that respective year, and sum the results to calculate an estimated age for individuals with that name.

The processing server 102 may also include a transmitting device 220. The transmitting device 220 may be configured to transmit data over one or more networks via one or more network protocols. In some embodiments, the transmitting device 220 may be configured to transmit data to social networks 106, data collection agencies 110, data requesters 112, and other entities via suitable communication networks, such as the Internet. In some embodiments, the transmitting device 220 may be comprised of multiple devices, such as different transmitting devices for transmitting data over different networks, such as a first transmitting device for transmitting data over a cellular communication network and a second transmitting device for transmitting data over the Internet. The transmitting device 220 may electronically transmit data signals that have data encoded that may be parsed by a receiving computing device. In some instances, the transmitting device 220 may include one or more modules for encoding or otherwise formatting data into data signals suitable for transmission.

The transmitting device 220 may be configured to electronically transmit data signals to social networks 106 that are encoded with user data requests. The user data requests may specify a user 104 or users 104 for which user data, that includes names of connections 108, is requested. The transmitting device 220 may also be configured to electronically transmit data signals to data collection agencies 110 that are encoded with name and demographic association requests. In some instances, such requests may also include additional characteristics for which demographics are to be associated, such as a combination of name and geographic location. The transmitting device 220 may also be configured to electronically transmit data signals to data requesters 112, such as may be encoded with responses to received data requests, such as including demographic characteristics or user profiles 212 requested by the data requester 112.

The processing server 102 may also include a memory 222. The memory 222 may be configured to store data for use by the processing server 102 in performing the functions discussed herein. The memory 222 may be configured to store data using suitable data formatting methods and schema and may be any suitable type of memory, such as read-only memory, random access memory, etc. The memory 222 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art.

As discussed above, the processing server 102 may be specifically configured to perform the functions discussed herein for the analysis of user data and identification of demographic characteristics associated with connections 108 for a user 104 of a social network 106. As part of the specialized configuration, the processing server 102 may store (e.g., in the memory 222) a plurality of functions for execution by the processing unit and various modules or engines of the processing server 102 for performing the actions of the processing server 102 discussed herein. For example, the memory 222 may include a get_account_data(account_url) function, which may be configured to scrape account information from the social network 106 page for a specified user 104, based on the account_url provided. Such a function may operate as a request for the user data, where the account_url may indicate the user 104 for which the data is requested.

The memory 222 may also include a is_boy_or_girl(first_name) function, which may check a specified name (e.g., as associated with a connection 108 to the user 104) for association with a male or female gender. The function may include, for instance, the generation and execution of a query by the querying module 214 on the association database 206 to identify an association profile 208 that includes the provided first_name value, and the identification of the gender value stored for the gender demographic label in the association profile 208. Additional functions that may be stored in the memory 222 and executed by the processing server 102 to perform the functions discussed herein may include functions for identifying an age, age range, birth year, or birth year range for a specified name, identifying ethnicity for a specified name (e.g., given name or surname), identifying a number of connections 108 for a user 104, the building of tables for representations of identified demographic characteristics, calculation of percentages of demographic characteristics, etc.

### Process for Analyzing User Data to Identify Connected Demographic Characteristics

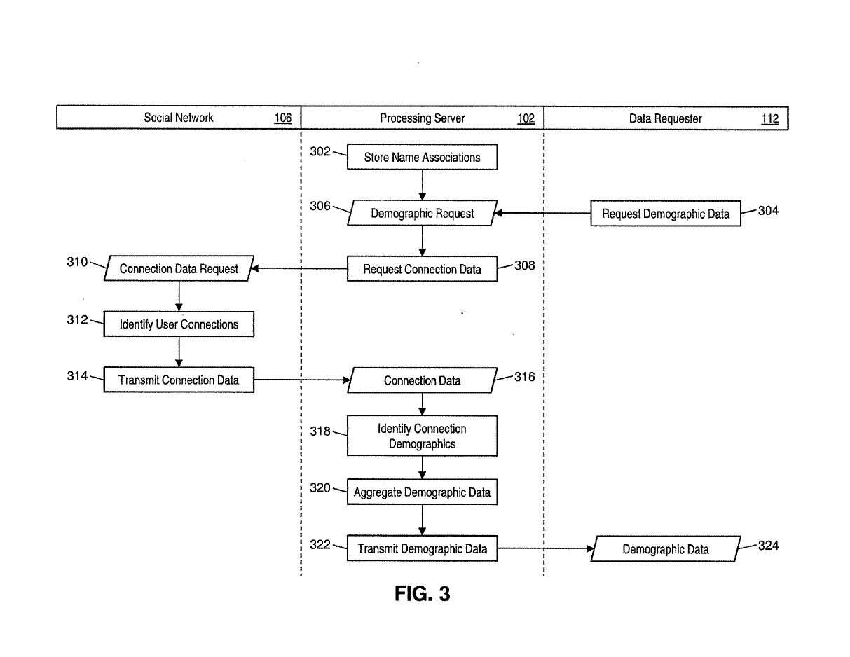

FIG. 3 illustrates a process for the analysis of user data for the user 104 of a social network 106 for the identification of demographic characteristics for connections 108 associated with the user 104 on the social network 106.

In step 302, the processing server 102 may store a plurality of association profiles 208 in the association database 206, where each association profile 208 includes at least a name, one or more demographic labels, and, for each demographic label, at least one demographic value associated with the respective name. The data stored in each association profile 208 may be based on data received by the receiving device 202 of the processing server 102 from the data collection agencies 110. In step 304, the data requester 112 may electronically transmit a data signal to the processing server 102 using a suitable communication network and method, where the data signal is encoded with a request for demographic data. The request for demographic data may include at least an identification value associated with a user 104 for which the demographic data is requested. The identification value may be, for example, a name, username, email address, telephone number, identification number, device identifier, or other suitable value. In some embodiments, the request for demographic data may also include one or more demographic labels for which demographic characteristics are requested.

In step 306, the receiving device 202 of the processing server 102 may receive and parse the request for demographic data. In step 308, the transmitting device 220 of the processing server 102 may electronically transmit a data signal to the social network 106 that is encoded with a request for connection data. The request for connection data may include at least the identification value associated with the user 104 for which data is requested, and may request at least the name provided for each connection 108 connected to the user 104 on the social network 106. In step 310, the social network 106 may receive the request for connection data.

In step 312, the social network 106 may identify each of the users connected to the user 104 that corresponds to the provided identification value on the social network 106, referred to herein as connections 108 to the user 104. In step 314, the social network 106 may electronically transmit a data signal back to the processing server 102 using a suitable communication network and method that is encoded with connection data that includes at least the name provided for each of the identified connections 108. In some instances, the connection data may also include additional data provided by each connection 108, such as a geographic location, age, age range, nationality, etc. In step 316, the receiving device 202 of the processing server 102 may receive and parse the connection data.

In step 318, the querying module 214 of the processing server 102 may execute queries on the association database 206 of the processing server 102 to identify association profiles 208 for each of the provided names for the connections 108 as included in the received connection data. In step 320, the data aggregation module 216 of the processing server 102 may aggregate the demographic values for each of the demographic labels included in each of the association profiles 208 identified by the querying module 214 in step 318. The result may be an aggregation of demographic values for each demographic label for all of the connections 108 connected to the user 104 on the social network 106. In step 322, the transmitting device 220 of the processing server 102 may electronically transmit a data signal to the data requester 112 using a suitable communication network and method that is encoded with at least the aggregated demographic values. In step 324, the data requester 112 may receive their requested demographic data.

### Process for Identifying Demographically Suitable Users Based on User Data Analysis

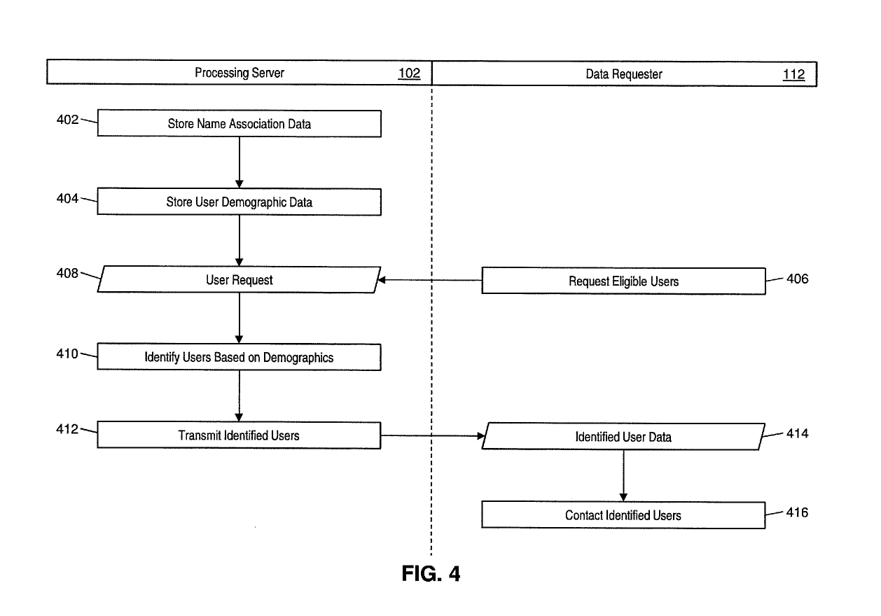

FIG. 4 illustrates a process for the identification of one or more users 104 of a social network 106 whose connections 108 fit a specified demographic profile as requested based on user data analysis done for the connections 108 for each user 104 of the social network 106.

In step 402, the processing server 102 may store name association data as association profiles 208 in the association database 206 of the processing server 102. Each association profile 208 may include at least a name, one or more demographic labels, and, for each demographic label, at least one demographic value associated with the respective name. The data stored in each association profile 208 may be based on data received by the receiving device 202 of the processing server 102 from the data collection agencies 110. In some instances, each association profile 208 may include additional data, such as a demographic value or characteristic associated with the name to which the included demographic labels and values apply.

In step 404, the processing server 102 may store user demographic data as a plurality of user profiles 212 in the user database 210 of the processing server 102. Each user profile 212 may include data related to a user 104 of a social network 106 and may include an identification value for the respective user 104 and aggregated demographic characteristics for the connections 108 of the respective user 104 as identified by the processing server 102 using the methods discussed herein.

In step 406, the data requester 112 may electronically transmit a data signal to the processing server 102 using a suitable communication network and method that is encoded with a request for eligible users. The request for eligible users may include at least one or more desired criteria for demographic values of a user 104 of a social network 106. In some instances, the request may specify the social network 106 or additional criteria, such as number of connections 108 for the desired user. The desired criteria for demographic values may include percentages or other representations of the demographic values and may include additional criteria associated therewith. For example, a data requester 112 may request users 104 whose connections 108 are at least 75% female, with the number of females being at least 10,000, based on the identified demographics percentage for that user's connections 108 and the user's number of connections 108. In step 408, the receiving device 202 of the processing server 102 may receive and parse the request.

In step 410, the querying module 214 of the processing server 102 may execute a query on the user database 210 to identify one or more user profiles 212 where the included demographic values satisfy the criteria set forth in the request for eligible users. In some embodiments, the analytical module 218 of the processing server 102 may be configured to perform analysis on the identified user profiles 212, such as to select one or more user profiles 212 from the identified set, which may be based on additional criteria included in the request for eligible users.

In step 412, the transmitting device 220 of the processing server 102 may electronically transmit a data signal to the data requester 112 using a suitable communication network and methods that is encoded with at least the identification value included in each of the identified user profiles 212. In some instances, the user profiles 212 themselves or additional data included therein may be included in the data provided to the data requester 112, such as for use by the data requester 112 in further selection of users 104. In step 414, the data requester 112 may receive the data regarding the identified users 104 and, in step 416, may contact suitable users 104, such as to seek assistance in promoting a product, purchasing a product, voting for a candidate, etc.

### Demographic Values as Analysis of User Data

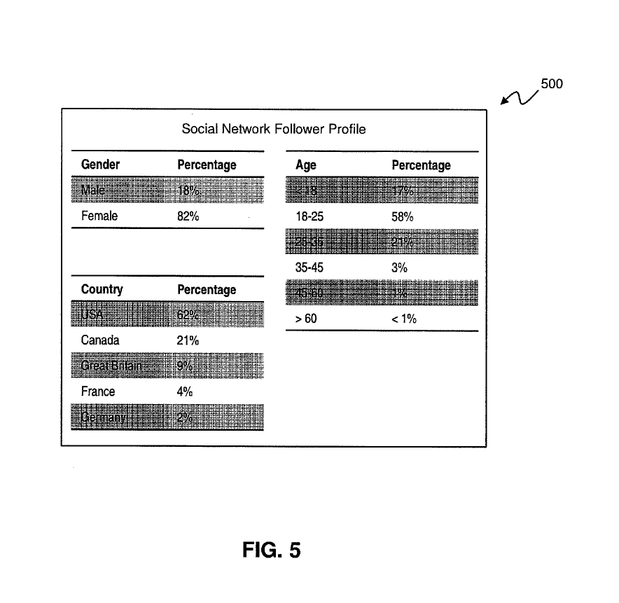

FIG. 5 illustrates demographic values for connections 108 for a user 104 of a social network 104 as identified by the processing server 102 using the methods discussed herein. For example, the table 500 illustrated in FIG. 5 and discussed below may be provided to a data requester 112 in response to a request for demographic characteristics for a specific user 104, as performed in the process illustrated in FIG. 3 and discussed above.

As illustrated in the table 500, the processing server 102 may be configured to identify and aggregate demographic values for one or more demographic labels for a user 104 of a social network 106 as related to the connections 108 of that user 104, based on the names provided by the connections 108 to the social network 106. In the illustrated example, the processing server 102 has analyzed the gender, country, and age range for each of the connections 108 for a specified user 104 of a social network 106.

In the illustrated example, the processing server 102 has determined, based on the names of the connections 108 for the user 104, that 18% of the user's connections 108 on the social network 106 are male, and 82% are female. A majority of the user's connections 108 live in the United States and are between the ages of 18 and 25. Such an analysis may reveal that the user 104 may be beneficial for use in reaching a target market of women up to 35 years old that live in North America, as up to 82% of the user's connections 108 meet that criteria, depending on how many of the 82% of the women fall into the 83% living in North America and 96% under 35.

### Exemplary Method for Analyzing User Data Based on Social Network Connections

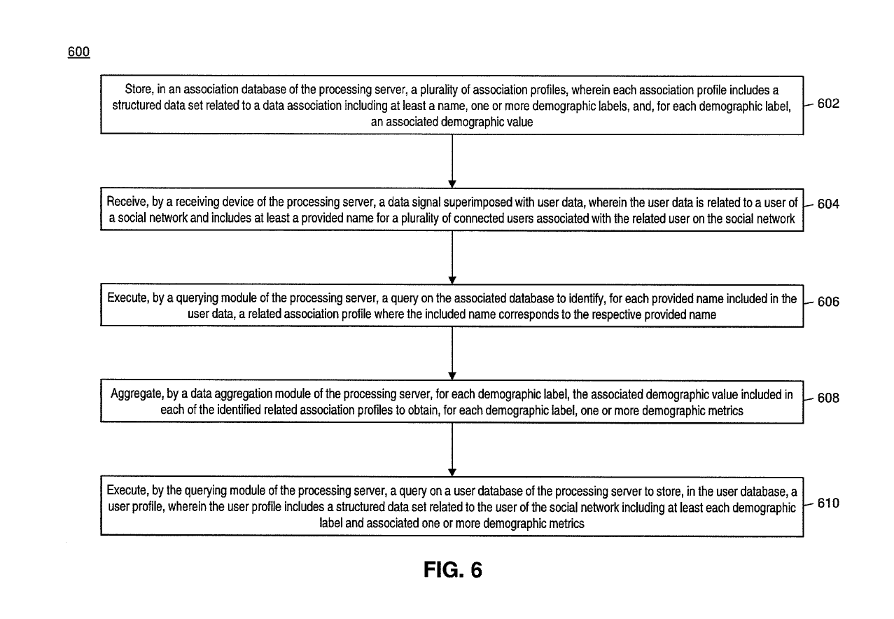

FIG. 6 illustrates a method 600 for the analysis of user data based on social network connections for identifying the demographic characteristics of connections to a user of a social network based on names provided for that user's connections and associations of names to demographic values.

In step 602, a plurality of association profiles (e.g., association profiles 208) may be stored in an association database (e.g., the association database 206) of a processing server (e.g., the processing server 102), wherein each association profile includes a structured data set related to a data association including at least a name, one or more demographic labels, and, for each demographic label, an associated demographic value. In step 604, a data signal encoded with user data may be received by a receiving device (e.g., the receiving device 202) of the processing server 102, wherein the user data is related to a user (e.g., the user 104) of a social network (e.g., the social network 106) and includes at least a provided name for a plurality of connected users (e.g., connections 108) associated with the related user on the social network.

In step 606, a query may be executed on the associated database by a querying module (e.g., the querying module 214) of the processing server to identify, for each provided name included in the user data, a related association profile where the included name corresponds to the respective provided name. In step 608, the associated demographic value included in each of the identified related association profiles may be aggregated by a data aggregation module (e.g., the data aggregation module 216) of the processing server to obtain, for each demographic label, one or more demographic metrics. In step 610, a query may be executed on a user database (e.g., the user database 210) of the processing server by the querying module of the processing server to store, in the user database, a user profile, wherein the user profile includes a structured data set related to the user of the social network including at least each demographic label and associated one or more demographic metrics.

In one embodiment, the method 600 may further include: receiving, by the receiving device of the processing server, a data signal encoded with a user information request, wherein the user information request specifies the user of the social network; and electronically transmitting, by a transmitting device (e.g., the transmitting device 220) of the processing server, a data signal encoded with at least each demographic label and associated one or more demographic metrics in response to the received data signal. In a further embodiment, the method 600 may also include electronically transmitting, by the transmitting device of the processing server, a data signal encoded with a user data request to the social network, wherein the user data request includes at least a user identifier associated with the user of the social network, and the data signal encoded with the user data is received in response to the user data request. In an even further embodiment, the user identifier may be included in the user information request.

In some embodiments, each association profile may further include a geographic location, the user data may further include a provided location for each of the plurality of connected users, and the related association profile identified for each provided name included in the user data may include a geographic location that corresponds to the provided location associated with the respective provided name. In one embodiment, each association profile may further include an age range, the user data may further include a provided age for each of the plurality of connected users, and the related association profile identified for each provided name included in the user data may include an age range that encompasses the provided age associated with the respective provided name. In some embodiments, the one or more demographic labels may include at least one of: age, gender, geographic location, ethnicity, income, education, occupation, residential status, familial status, and marital status.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 4, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for analyzing user data based on social network connections. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for analyzing user data based on social network connections, comprising:
storing, in an association database of the processing server, a plurality of association profiles, wherein each association profile includes a structured data set related to a data association including at least a name, one or more demographic labels, and, for each demographic label, an associated demographic value;
receiving, by a receiving device of the processing server, a data signal encoded with user data, wherein the user data is related to a user of a social network and includes at least a provided name for a plurality of connected users associated with the related user on the social network;
executing, by a querying module of the processing server, a query on the associated database to identify, for each provided name included in the user data, a related association profile where the included name corresponds to the respective provided name;
aggregating, by a data aggregation module of the processing server, for each demographic label, the associated demographic value included in each of the identified related association profiles to obtain, for each demographic label, one or more demographic metrics; and
executing, by the querying module of the processing server, a query on a user database of the processing server to store, in the user database, a user profile, wherein the user profile includes a structured data set related to the user of the social network including at least each demographic label and associated one or more demographic metrics.

2. The method of claim 1, further comprising:
receiving, by the receiving device of the processing server, a data signal encoded with a user information request, wherein the user information request specifies the user of the social network; and
electronically transmitting, by a transmitting device of the processing server, a data signal encoded with at least each demographic label and associated one or more demographic metrics in response to the received data signal.

3. The method of claim 2, further comprising:
electronically transmitting, by the transmitting device of the processing server, a data signal encoded with a user data request to the social network, wherein
the user data request includes at least a user identifier associated with the user of the social network, and
the data signal encoded with the user data is received in response to the user data request.

4. The method of claim 3, wherein the user identifier is included in the user information request.

5. The method of claim 1, wherein
each association profile further includes a geographic location,
the user data further includes a provided location for each of the plurality of connected users, and
the related association profile identified for each provided name included in the user data includes a geographic location that corresponds to the provided location associated with the respective provided name.

6. The method of claim 1, wherein
each association profile further includes an age range,
the user data further includes a provided age for each of the plurality of connected users, and
the related association profile identified for each provided name included in the user data includes an age range that encompasses the provided age associated with the respective provided name.

7. The method of claim 1, wherein the one or more demographic labels includes at least one of: age, gender, geographic location, ethnicity, income, education, occupation, residential status, familial status, and marital status.

8. A system for analyzing user data based on social network connections, comprising:
an association database of the processing server configured to store a plurality of association profiles, wherein each association profile includes a structured data set related to a data association including at least a name, one or more demographic labels, and, for each demographic label, an associated demographic value;
a receiving device of the processing server configured to receive a data signal encoded with user data, wherein the user data is related to a user of a social network and includes at least a provided name for a plurality of connected users associated with the related user on the social network;
a querying module of the processing server configured to execute a query on the associated database to identify, for each provided name included in the user data, a related association profile where the included name corresponds to the respective provided name; and
a data aggregation module of the processing server configured to aggregate for each demographic label, the associated demographic value included in each of the identified related association profiles to obtain, for each demographic label, one or more demographic metrics, wherein
the querying module of the processing server is further configured to execute a query on a user database of the processing server to store, in the user database, a user profile, wherein the user profile includes a structured data set related to the user of the social network including at least each demographic label and associated one or more demographic metrics.

9. The system of claim 8, further comprising:
a transmitting device of the processing server, wherein
the receiving device of the processing server is further configured to receive a data signal encoded with a user information request, wherein the user information request specifies the user of the social network, and
the transmitting device of the processing server is configured to electronically transmit a data signal encoded with at least each demographic label and associated one or more demographic metrics in response to the received data signal.

10. The system of claim 9, wherein
the transmitting device of the processing server is further configured to electronically transmit a data signal encoded with a user data request to the social network,
the user data request includes at least a user identifier associated with the user of the social network, and
the data signal encoded with the user data is received in response to the user data request.

11. The system of claim 10, wherein the user identifier is included in the user information request.

12. The system of claim 8, wherein
each association profile further includes a geographic location,
the user data further includes a provided location for each of the plurality of connected users, and
the related association profile identified for each provided name included in the user data includes a geographic location that corresponds to the provided location associated with the respective provided name.

13. The system of claim 8, wherein
each association profile further includes an age range,
the user data further includes a provided age for each of the plurality of connected users, and
the related association profile identified for each provided name included in the user data includes an age range that encompasses the provided age associated with the respective provided name.

14. The system of claim 8, wherein the one or more demographic labels includes at least one of: age, gender, geographic location, ethnicity, income, education, occupation, residential status, familial status, and marital status.

15. A non-transitory computer readable recording medium configured to store program code executable by a processing device of a computing system for analyzing user data based on social network connections, wherein the program code is configured to cause the computing system to:
store, in an association database of the processing server, a plurality of association profiles, wherein each association profile includes a structured data set related to a data association including at least a name, one or more demographic labels, and, for each demographic label, an associated demographic value;
receive, by a receiving device of the processing server, a data signal encoded with user data, wherein the user data is related to a user of a social network and includes at least a provided name for a plurality of connected users associated with the related user on the social network;
execute, by a querying module of the processing server, a query on the associated database to identify, for each provided name included in the user data, a related association profile where the included name corresponds to the respective provided name;
aggregate, by a data aggregation module of the processing server, for each demographic label, the associated demographic value included in each of the identified related association profiles to obtain, for each demographic label, one or more demographic metrics; and
execute, by the querying module of the processing server, a query on a user database of the processing server to store, in the user database, a user profile, wherein the user profile includes a structured data set related to the user of the social network including at least each demographic label and associated one or more demographic metrics.

16. The non-transitory computer readable recording medium of claim 15, wherein the program code is further configured to cause the computing system to:
receive, by the receiving device of the processing server, a data signal encoded with a user information request, wherein the user information request specifies the user of the social network; and
electronically transmit, by a transmitting device of the processing server, a data signal encoded with at least each demographic label and associated one or more demographic metrics in response to the received data signal.

17. The non-transitory computer readable recording medium of claim 16, wherein the program code is further configured to cause the computing system to:
electronically transmit, by the transmitting device of the processing server, a data signal encoded with a user data request to the social network, wherein
the user data request includes at least a user identifier associated with the user of the social network, and
the data signal encoded with the user data is received in response to the user data request.

18. The non-transitory computer readable recording medium of claim 17, wherein the user identifier is included in the user information request.

19. The non-transitory computer readable recording medium of claim 15, wherein each association profile further includes a geographic location,
the user data further includes a provided location for each of the plurality of connected users, and
the related association profile identified for each provided name included in the user data includes a geographic location that corresponds to the provided location associated with the respective provided name.

20. The non-transitory computer readable recording medium of claim 15, wherein
each association profile further includes an age range,
the user data further includes a provided age for each of the plurality of connected users, and
the related association profile identified for each provided name included in the user data includes an age range that encompasses the provided age associated with the respective provided name.
